(19) United States
(12) Patent Application Publication
(10) Pub. No.: US 2017/0017518 A1
(43) Pub. Date: Jan. 19, 2017

(54) Method of Automatic Allocation of Processing Power and System Resource for Image Viewing and Processing Application

(71) Applicant: Capso Vision, Inc., Saratoga, CA (US)

(72) Inventors: Kang-Huai Wang, Saratoga, CA (US); Yi Xu, Menlo Park, CA (US)

(73) Assignee: Capso Vision, Inc.

(21) Appl. No.: 14/803,030

(22) Filed: Jul. 18, 2015

(51) Int. Cl. G06F 9/48

(52) U.S. Cl. CPC G06F 9/485

(57) ABSTRACT

A method of automatic allocation of processing power and system resource for an image viewing and processing application is disclosed. The usage of a processing unit or system resources consumed by other computing-processes on the computer is determined. The usage required by the image viewing and processing application is determined. Then, based on the usage consumed by other computing-processes and the usage required by the image viewing and processing application, the adequacy of the processing unit or system resources for executing the image viewing and processing application is assessed. If the adequacy of the processing unit or system resources for executing the image viewing and processing application is not satisfied, the usage of the processing unit or system resources consumed by other computing-processes associated with other applications is displayed. Also, options to select one or more other applications for termination via a user interface are displayed. The selected applications selected are terminated to reduce the usage of the processing unit or system resources.

### FIELD OF THE INVENTION

The present invention relates to a method for automatic allocation of processing power and system resource for an image viewing and processing application to ensure smooth running of the image viewing and processing application.

### BACKGROUND AND RELATED ART

Devices for imaging body cavities or passages in vivo are known in the art and include endoscopes and autonomous encapsulated cameras. Endoscopes are flexible or rigid tubes that pass into the body through an orifice or surgical opening, typically into the esophagus via the mouth or into the colon via the rectum. An image is formed at the distal end using a lens and transmitted to the proximal end, outside the body, either by a lens-relay system or by a coherent fiber-optic bundle. A conceptually similar instrument might record an image electronically at the distal end, for example using a CCD or CMOS array, and transfer the image data as an electrical signal to the proximal end through a cable. Because of the difficulty traversing a convoluted passage, endoscopes cannot reach the majority of the small intestine and special techniques and precautions, that add cost, are required to reach the entirety of the colon. An alternative in vivo image sensor that addresses many of these problems is a capsule endoscope. A camera is housed in a swallowable capsule, along with a radio transmitter for transmitting data, primarily comprising images recorded by the digital camera, to a base-station receiver or transceiver and data recorder outside the body. Another autonomous capsule camera system with on-board data storage was disclosed in the U.S. patent application Ser. No. 11/533,304, filed on Sep. 19, 2006.

For the above in vivo devices, a large amount of image data is collected during the course of its traversing through a lumen in human body such as the gastrointestinal (GI) tract. For the autonomous capsule camera, the number of images collected may be as many as tens of thousands. The image data usually is viewed by medical professionals for diagnosis, analysis or other purposes. The image data is often displayed on a display device continuously and viewed video data at a certain frame rate, such as 30 frames per second. In order to help a viewer to navigate through the video sequence and to spot any possible anomaly in the sequence, certain image processing (e.g. object detection and/or segmentation) is performed in real-time during image viewing or during download process for camera system with on-board data storage. Such image processing may be rather CPU (central processing unit) intensive and may require many other system resources such as physical memory Such processing may be using a cloud service to perform certain tasks; thus, require network bandwidth to transmit data to and from the cloud server. Furthermore, the image viewing/processing application is often used in a normal medical office or laboratory environment. The image viewing/processing application is typically running on a desk-top or notebook computer. Multi-threaded applications have been a trend in today's programming environment. Besides the image viewing/processing application, there are likely many other programs running concurrently on the computer and consume CPU power and system resources. Due to limited CPU power and system resources, other concurrent applications may cause inadequate CPU power and/or system resources for the image viewing/processing application. Therefore, it is desirable to develop a means for monitoring CPU and/or system resource usage and allow a viewer to react in order to ensure smooth running of the image viewing/processing application.

### SUMMARY OF THE INVENTION

A method of automatic allocation of processing power and system resource for an image viewing and processing application is disclosed. According to one embodiment, the usage of a processing unit or one or more system resources consumed by other computing-processes on the computer is determined. Also the usage required by the image viewing and processing application is determined. Then, based on the usage consumed by other computing-processes and the usage required by the image viewing and processing application, the adequacy of the processing unit or system resources for executing the image viewing and processing application is assessed. If the adequacy of the processing unit or system resources for executing the image viewing and processing application is not satisfied, the usage of the processing unit or system resources consumed by other computing-processes associated with other applications is displayed. Also, options to select one or more other applications for termination via a user interface are displayed. The one or more other applications selected are terminated to reduce the usage of the processing unit or system resources consumed by other computing-processes on the computer so as to ensure the adequacy of the processing unit or said one or more system resources for executing the image viewing and processing application.

The usage of the processing unit or system resources consumed by other computing-processes is measured multiple times over a period of time. On the other hand, the usage of the processing unit or system resources required by the image viewing and processing application is estimated. The adequacy of the processing unit or system resources for executing the image viewing and processing application is assessed based on a worst case of the usage of the processing unit or system resources consumed by other computing-processes. Also, the adequacy of the processing unit or system resources for executing the image viewing and processing application is assessed based on a worst case of the usage of the processing unit or system resources required by the image viewing and processing application. Furthermore, the adequacy of the processing unit or system resources for executing the image viewing and processing application is asserted if remaining resources is larger than the usage of the processing unit or said one or more system resources required by the image viewing and processing application by a threshold. The remaining resources of the processing unit or system resources corresponds to a total available processing unit or system resources less the usage of the processing unit or system resources consumed by other computing-processes. The threshold can be set by a user.

The options to select one or more other applications for termination via the user interface may include a box or an icon associated with a selected application to be terminated, where the box or icon can be selected using a pointing device. In addition, a target usage of the processing unit or system resources to be reduced can be displayed if the adequacy of the processing unit or system resources for executing the image viewing and processing application is not satisfied. The method of ensuring allocation of sufficient processing power and system resource for the image viewing and processing application can be performed before executing the image viewing and processing application. The method of ensuring allocation of sufficient processing power and system resource for the image viewing and processing application can be integrated into the image viewing and processing application. The system resources may correspond to memory size, system bandwidth, network bandwidth, or any combination thereof.

### BRIEF DESCRIPTION OF THE DRAWINGS

FIGS. 1A-B illustrate an example of user interface design incorporating an embodiment of the present invention for displaying usage of CPU and memory by other applications and displaying options to select application for termination.

FIG. 2 illustrates an exemplary flowchart of ensuring allocation of sufficient processing power and system resource for an image viewing and processing application according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely a representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

As mentioned before, in order to help a viewer to navigate through the large amount of capsule images and to spot any possible anomaly in the sequence, image viewing/processing application is provided. The software is often executed on personal computers, where the CPU processing power and/or system resources may be very limited. On the other hand, the image viewing/processing application may be very demanding in CPU processing power and/or system resources. For example, a capsule system may also include a download function in addition to the image viewing/processing. During the downloading operation, the capsule system not only downloads image data but also performs real-time processing on the downloaded image data. For example, the captured images may be stored in a compressed form in the capsule device. The image data downloaded may have to be decompressed in real time, CPU processing power as well as memory bandwidth. During image viewing/processing, individual images may be composed to form a larger image in order to make image viewing more efficiently. Such processing not only requires high CPU usage but also consumes high system bandwidth for accessing image data from storage The processing unit in an updated computer may correspond to a multi-core processor. In this disclosure, a processing unit or a CPU also refers to multi-core CPU used in a computer.

Among system resources, data bandwidth resource is another important factor to take into consideration. The data bandwidth resource may involve wired interfaces (e.g. Ethernet, USB) and wireless interfaces (e.g. WiFi and Bluetooth). For example, the image processing associated with the capsule images may be highly computational intensive and may take long time for the computer with constrained CPU processing power to perform the tasks. Accordingly, distributed computing or cloud computing may be used to offload the processing to remote computers by transmitting some image data through networks to remote computers. The processed or partially processed image data or parameters extracted from the image data may be sent back to the computer for further processing or display. In another example, the large amount of image data may be stored on board inside a capsule camera. The large amount of image data may be retrieved from the capsule camera via an interface device (e.g. a docking station) via a USB port on the computer. It may be desirable to download the large amount of image data to the computer as quick as possible. Therefore, the data bandwidth is also a key factor to monitor and to assess whether there will be sufficient bandwidth remained for the image viewing/processing application.

Due to parallel or multi-threaded applications, the computer may also be running other application along with the image viewing/processing application. Therefore, other parallel or multi-threaded applications will be competing for the CPU processing power and/or system resources with the image viewing/processing application. For example, a word processing application may be idle in the background. While the program hardly consumes any CPU processing power, the program may require large system memory if the underlying word processing file is large. When the total memory consumed by all applications exceeds the physical memory size, the system may have to swap memory pages in order to support parallel or multi-threaded execution of applications. Such memory page swapping may slow down the program execution and may even prevent normal program execution. Therefore, the present invention discloses means to monitor and alert users of any risk of CPU processing power and/or system resource issues. Accordingly, the system incorporating embodiments of the present invention will provide options for users to react in order to avoid such issues.

The requirement of CPU processing power and/or system resources associated with the image viewing/processing application is evaluated for various stages or phases of the program execution. For example, the software may allow a user to view the images in a video mode, where the individual capsule images are treated as a video sequence and are displayed at a given frame rate such as 30 frames per second. The software may also provide an advanced viewing mode, where multiple capsule images are stitched into a large composite image for time efficient viewing. While both modes may require large amount of data access from storage, the advanced viewing mode will also consume much higher CPU processing power. Accordingly, it is desirable to restrict storage (e.g., hard disk or memory stick) access for other applications when or before the image viewing/processing application is executed. Furthermore, it may also be desirable to restrict the CPU processing power consumption for other applications, especially when the advanced viewing mode is used. In computer programming environment, each application is associated with a corresponding process (also named computing process in this disclosure). Multiple instances of an application may correspond to multiple processes. For example, an internet browser, such as “chrome” browser, may be opened in multiple windows and will trigger multiple corresponding processes. Furthermore, there are processes associated with operating system or host processing. For example, “rundll.exe” process is part of Window operating system and always running Usually, these processes consume very little CPU processing power and/or system resources. Furthermore, these processes may be critical for proper system operation. Accordingly, in one embodiment, these processes related to operating system will not be subject to termination.

In one embodiment, a monitoring/user-interface software module monitors the CPU processing power and/or system resources consumed by other applications. Furthermore, the monitoring/user-interface software module also assesses the required CPU processing power and/or system resources consumed by the image viewing/processing application. According to the CPU processing power and/or system resources consumed by other applications and required by the image viewing/processing application, the monitoring/user-interface software module will assess the risk of insufficiency of CPU processing power and/or system resources that may affect proper execution of the image viewing/processing application. Furthermore, the monitoring/user-interface software module will display to viewers the options to release the CPU processing power and/or system resources associated with other applications by terminating selected applications.

The CPU processing power and/or system resources consumed by other applications can be monitored by issuing system functional calls. For example, in various operating system (OS), corresponding API (application program interface) is often provided to allow a programmer to call system functions to obtain desired system information such as the process identification (PID) associated with various applications, the CPU processing power consumption associated with each PID, the memory space used, etc. On the other hand, the CPU processing power and/or system resources required by the image viewing/processing application can be measured in a same way as other application. However, the CPU processing power and/or system resources required by the image viewing/processing application may also be estimated for various phases or stages of the software execution. Since the software may be running on different computers with different processors at different operating frequencies, the estimated CPU processing power and/or system resources may be provided for a set of commonly used processors at different frequencies with different system configurations. During live processing, the estimation may be provided by finding the configuration that is closest to the current system. For example, different DRAM (dynamic random access memory) size and memory technologies may be used for a computer. The total DRAM size may be 2, 4, 8, 16 GB (giga-bytes) or larger. Different DRAM technologies, such as double data rate (DDR) synchronous dynamic random-access memory (SDRAM), may be used. Furthermore, different DDR technologies (e.g. DDR type 3, DDR3 or DDR type 4, DDR4) with different memory clocks (e.g. 200 MHz or 400 MHz) may be used. The DRAM configuration will determine the total physical memory and system bandwidth allowed.

The image viewing/processing application may load all picture data into memory. However, when a large number of pictures are viewed in a video mode, the picture data may have to be read from a storage device, such as a hard drive, into the memory. Therefore, the data access will also consume disk access time, disk bandwidth and system bandwidth. The image viewing/processing application may apply various processing to the loaded picture data. The image data may have to be accessed (read or write) from the memory multiple times, which will consume very high system bandwidth. Furthermore, depending on the particular processing, the image viewing/processing application may consume very high CPU processing power. While the CPU processing power and/or system resources consumed by the image viewing/processing application may be monitored on the fly this would not help to prevent possible shortage of processing power and/or system resources when the image viewing/processing application is executed with other applications at the same time (e.g. parallel or multi-threading). Therefore, it is desirable to analyze the CPU processing power and/or system resource usage and prevent possible shortage in the CPU processing power and/or system resources before the heavy CPU processing power and/or system resource consumption starts and causes problem.

According to one embodiment, the monitoring/user-interface software module evaluates the CPU processing power and/or system resource consumption by other applications, estimates the CPU processing power and/or system resource consumption by the image viewing/processing application, and assesses adequacy of the CPU processing power and/or system resources for the image viewing/processing application. If the monitoring/user-interface software module determines any risk of performance impairment of the image viewing/processing application due to inadequate CPU processing power and/or system resources, the monitoring/user-interface software module will provide audio, visual or both signal to alert the viewer of the possible problem. Furthermore, the monitoring/user-interface software module will provide options to the viewer to reduce the CPU processing power and/or system resources by closing down selected applications.

In one embodiment of the present invention, the assessment of sufficiency of the CPU processing power and/or system resources is performed. For example, if the CPU processing power used by other applications is known, the remaining CPU processing power available for the image viewing/processing application can be determined by

P_{remaining}=(1−Pₒₜₕₑᵣ), (1)

where Pₒₜₕₑᵣ corresponds to the CPU processing power in percentage of the total CPU processing power used by other applications. P_{remaining} corresponds to the remaining CPU processing power in percentage of the total CPU processing power.

On the other hand, the CPU processing power required by the image viewing/processing application is estimated as P_{SW}. It is desirable to leave margin to ensure the remaining CPU processing power is sufficient to execute the image viewing/processing application. Therefore, it is desirable to ensure,

(P_{remaining}−P_{SW})≧Pₜₕᵣₑₛₕ, (2)

where Pₜₕᵣₑₛₕ corresponds to a threshold. The threshold is a positive value. For example, if a 10% margin is desired, Pₜₕᵣₑₛₕ can be set to 0.1 (i.e., 10%).

A default threshold can be initially set. However, the threshold can also be modified by a user. The modified threshold may be stored for subsequent use so that the user does not need to set the threshold every time. Furthermore, the threshold can be stored in user preference setting.

The CPU processing power consumption usually fluctuates. Therefore, according to one embodiment of the present invention, multiple observations or measuring of the CPU processing power consumption are made in order to provide more reliable information. In order to enhance smooth program execution, the monitoring and control is designed according to the worst case scenario. For example, the assessment of the remaining CPU processing power as shown in equation (1) is based on the worst case, i.e., the peak CPU processing power consumption. Similarly, the estimated CPU process power for the image viewing/processing application is also based on the peak value. Accordingly, the monitoring/user-interface software module will be able to determine whether the remaining CPU processing power is adequate to support smooth running of the image viewing/processing application with the other applications running at the same time.

If the monitoring/user-interface software module determines that the remaining CPU processing power may not be sufficient to support smooth running of the image viewing/processing application, the monitoring/user-interface software module will alert the viewer the risk. At the same time, the monitoring/user-interface software module will offer the viewer options to reduce the CPU processing power consumption by other applications. For example, the list of other applications with respective CPU processing power consumption can be displayed on a display device. For example, the computer display or the laptop screen used for display the capsule images can also be used for user interface to display the information and allow the user to make decision through user interface. User interface, particularly graphic user interface (GUI) has been widely used in the field to allow a user to enter selection or feedback using a pointing device such as a computer mouse or a track ball, or a computer keyboard/keypad or by human finger on touchable devices The user can enter input using computer mouse, track ball or a computer keyboard/keypad, or a virtual keyboard easily with the text/graphic guides displayed on the display.

While the CPU processing power has been used as an example for the monitoring/user-interface software module to evaluate whether the remaining CPU processing power is sufficient to support smooth running of the image viewing/processing application. Similarly, the monitoring/user-interface software module may also monitor and assess system resources to ensure the remaining system resources to be sufficient for the image viewing/processing application. For example, the system memory usage can also be monitored to ensure there will be sufficient remaining memory space for the image viewing/processing application. Since any issue with the CPU processing power and the system resources will have impact on the smooth running of the image viewing/processing application, an embodiment of the present invention will assess CPU processing power and at least one key system resource such as the memory usage or system bandwidth usage.

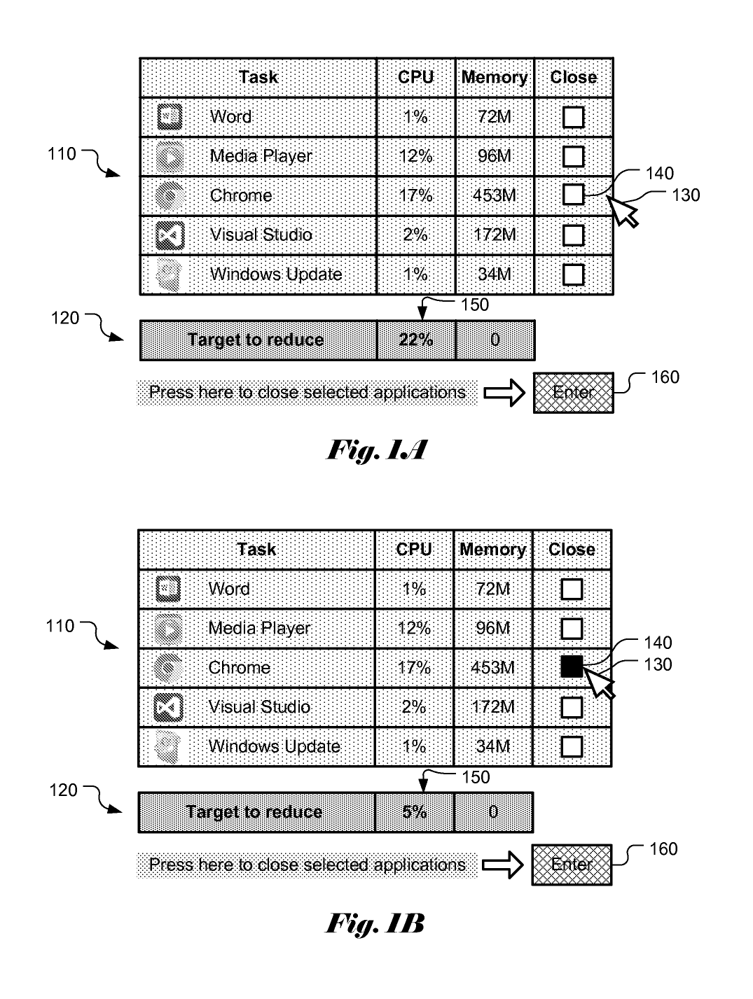

FIG. 1A illustrates an example of user interface design incorporating an embodiment of the present invention. Major other applications consuming significant CPU processing power or system resources are shown in area 110. There may be more applications that are running in the background consuming very little CPU processing power and very little system resources. These applications will not have much impact on the image viewing/processing application and can be ignored for application termination while the total CPU processing power and system resources may still be counted. In the example, the application is identified by the application name as well as an associated icon. For example, word processing software “Word” is shown next to an associated icon and the consumed CPU processing power (i.e., 1%) and memory space (i.e., 72 MB (mega-byte)). On the other hand, an internet browser “Chrome” consumes 17% CPU processing power and takes up 453 MB memory space. It appears that the browser is doing a lot of data crunching on the internet data using lots of memory space. It may be caused by one or multiple instances of the browsers (i.e., multiple browser windows opened).

Based on the collected data on CPU processing power and/or system resources used by other programs, the system can calculate remaining CPU processing power and/or system resources based on system configuration and performance specification (e.g. CPU type and clock, memory size and speed, etc.). As mentioned before, the required CPU processing power and/or system resources can be estimated for the specific system configuration and performance specification. Accordingly, whether the remaining CPU processing power and/or system resources will be sufficient to support the smooth running of the image viewing/processing application can be determined. In other words, the remaining CPU processing power and system resources should be larger than the required CPU processing power and system resources by the image viewing/processing application. As mentioned before, the remaining CPU processing power and/or system resources should be larger than the required CPU processing power and/or system resources by a margin as shown in equation (2). If Pₜₕᵣₑₛₕ is known, any shortage in the CPU processing power and/or system resources can be determined. If any shortage is determined, the monitoring/user-interface software module will provide options for the viewer to reduce the CPU processing power and/or system resources.

FIG. 1A illustrates an example of providing options for the viewer to reduce the CPU processing power and/or system resources via graphic user interface (GUI). In this example, a display (120) is used to indicate the shortage in the CPU processing power and/or system resources. For example, it indicates that 22% CPU processing power needs to be reduced. On the other hand, there is still enough memory space and the memory is not an issue in this example. Furthermore, the monitoring/user-interface software module provides a convenient means for the viewer to select and close applications. For example, a cursor (130) is displayed to allow the viewer to select the applications to be closed by pointing to a respective selection box (140) and clicking a left button on the pointing device. The selected box will be highlighted by changing the color of the box (140) as shown in FIG. 1B. The area for indicating target CPU yet to reduce (150) will be updated from 22% in FIG. 1A to 5% in FIG. 1B. The viewer may further check the box for the “Media Player” application for closing in order to meet the target to reduce. When selected applications for closing are enough to provide enough remaining CPU processing power for the image viewing/processing application, the monitoring/user-interface software module will indicate the condition. For example, when the “target to reduce” CPU becomes zero or negative, it indicates that the remaining CPU processing power is sufficient. Alternatively, other confirmation signal may be displayed.

After selected applications for closing are enough to provide sufficient CPU processing power for the image viewing/processing application, the viewer may make an indication to activate the termination of selected applications. For example, the viewer may point and click the “Enter” button to activate the termination of selected applications. Some application termination process may still require the viewer's attention and the viewer needs to make proper selection or confirmation before the program termination is complete. For example, if an associated file has been altered (e.g. a Word document), the system will require the user to indicate whether to save the changes. After all selected applications are terminated, the associated CPU processing power and system resources will be released. The image viewing/processing application can be started with sufficient CPU processing power and system resources.

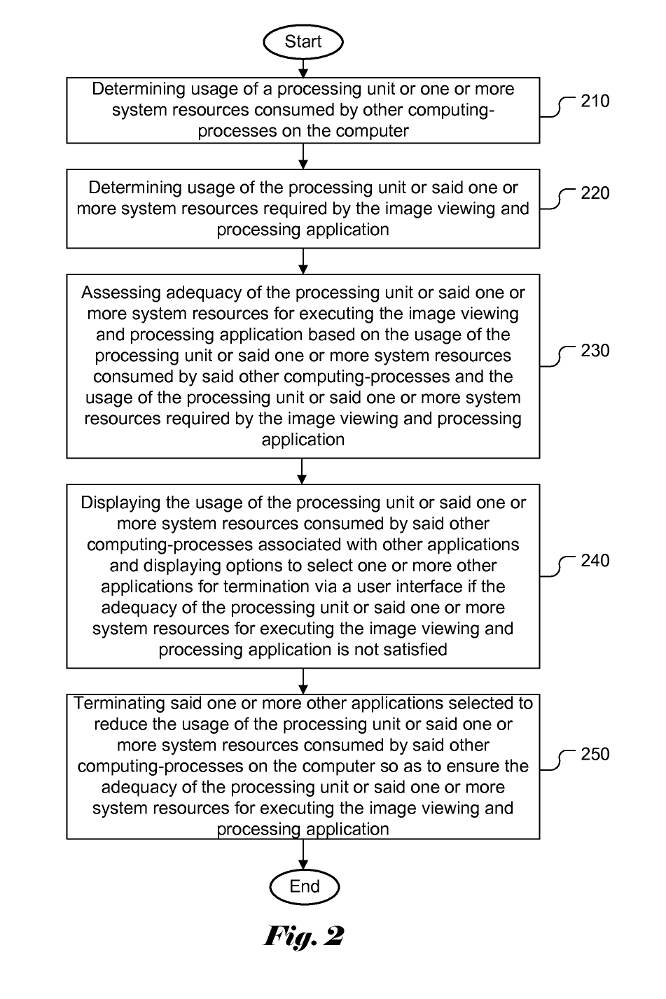

FIG. 2 illustrates an exemplary flowchart of ensuring allocation of sufficient processing power and system resource for an image viewing and processing application according to an embodiment of the present invention. The usage of a processing unit or one or more system resources consumed by other computing-processes on the computer is determined in step 210. The usage of the processing unit or said one or more system resources required by the image viewing and processing application is also determined in step 220.

In the above disclosure, the monitoring/user-interface software module is described as a separate module from the image viewing/processing application. Nevertheless, the monitoring/user-interface software module can be an integral part of the image viewing/processing application. When the image viewing/processing application is started, the monitoring/user-interface software module can be executed first to ensure sufficient CPU processing power and system resources before the main program of the image viewing/processing application is executed. The adequacy of the processing unit or said one or more system resources for executing the image viewing and processing application is assessed based on the usage of the processing unit or said one or more system resources consumed by said other computing-processes and the usage of the processing unit or said one or more system resources required by the image viewing and processing application in step 230. The usage of the processing unit or said one or more system resources consumed by said other computing-processes associated with other applications and displaying options to select one or more other applications for termination via a user interface if the adequacy of the processing unit or said one or more system resources for executing the image viewing and processing application is not satisfied in step 240. Said one or more other applications selected are terminated to reduce the usage of the processing unit or said one or more system resources consumed by said other computing-processes on the computer so as to ensure the adequacy of the processing unit or said one or more system resources for executing the image viewing and processing application in step 250.

The above method can be implemented as computer programs on a machine-readable medium to be executed on a computer. The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present invention. The machine-readable medium includes any mechanism that provides (i.e., stores and/or transmits) information in a form readable by a machine (e.g., a computer, tablet, smartphone, etc.). For example, a machine-readable medium includes memory (such as described above), optical storage media or flash memory devices can be used as the machine-readable medium.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Accordingly, the specification and drawings are to be regarded in an illustrative rather than a restrictive sense.

1. A method of automatic allocation of processing power and system resource for an image viewing and processing application in a computer, the method comprising:
determining usage of a processing unit or one or more system resources consumed by other computing-processes on the computer;
determining usage of the processing unit or said one or more system resources required by the image viewing and processing application;
assessing adequacy of the processing unit or said one or more system resources for executing the image viewing and processing application based on the usage of the processing unit or said one or more system resources consumed by said other computing-processes and the usage of the processing unit or said one or more system resources required by the image viewing and processing application;
displaying the usage of the processing unit or said one or more system resources consumed by said other computing-processes associated with other applications and displaying options to select one or more other applications for termination via a user interface if the adequacy of the processing unit or said one or more system resources for executing the image viewing and processing application is not satisfied; and
terminating said one or more other applications selected to reduce the usage of the processing unit or said one or more system resources consumed by said other computing-processes on the computer so as to ensure the adequacy of the processing unit or said one or more system resources for executing the image viewing and processing application.

2. The method of claim 1, wherein said determining the usage of the processing unit or said one or more system resources consumed by said other computing-processes measures the usage of the processing unit or said one or more system resources consumed by said other computing-processes multiple times over a period of time.

3. The method of claim 1, wherein said determining the usage of the processing unit or said one or more system resources required by the image viewing and processing application is based estimated usage of the processing unit or said one or more system resources required by the image viewing and processing application.

4. The method of claim 1, wherein said assessing the adequacy of the processing unit or said one or more system resources for executing the image viewing and processing application is based on a worst case of the usage of the processing unit or said one or more system resources consumed by said other computing-processes.

5. The method of claim 1, wherein said assessing the adequacy of the processing unit or said one or more system resources for executing the image viewing and processing application is based on a worst case of the usage of the processing unit or said one or more system resources required by the image viewing and processing application.

6. The method of claim 1, wherein said assessing the adequacy of the processing unit or said one or more system resources for executing the image viewing and processing application asserts the adequacy if the usage of the processing unit or said one or more system resources remaining is larger than the usage of the processing unit or said one or more system resources required by the image viewing and processing application by a threshold, wherein the usage of the processing unit or said one or more system resources remaining corresponds to a total available usage of the processing unit or said one or more system resources less the usage of the processing unit or said one or more system resources consumed by said other computing-processes.

7. The method of claim 6, wherein the threshold is set by a user.

8. The method of claim 1, wherein said displaying the options to select said one or more other applications for termination via the user interface displays a box or an icon associated with a selected application to be terminated, where the box or the icon is selectable using a pointing device.

9. The method of claim 1, further comprising displaying a target usage of the processing unit or said one or more system resources to be reduced if the adequacy of the processing unit or said one or more system resources for executing the image viewing and processing application is not satisfied.

10. The method of claim 1, wherein the method of automatic allocation of processing power and system resource for the image viewing and processing application is performed before executing the image viewing and processing application.

11. The method of claim 1, wherein the method of automatic allocation of processing power and system resource for the image viewing and processing application is integrated into the image viewing and processing application.

12. The method of claim 1, wherein said one or more system resources corresponds to memory size, system bandwidth, network bandwidth, or any combination thereof.

13. A computer readable recording medium with program instructions tangibly stored thereon for automatic allocation of processing power and system resource, the program instructions comprising instructions for:
determining usage of a processing unit or one or more system resources consumed by other computing-processes on the computer;
determining usage of the processing unit or said one or more system resources required by the image viewing and processing application;
assessing adequacy of the processing unit or said one or more system resources for executing the image viewing and processing application based on the usage of the processing unit or said one or more system resources consumed by said other computing-processes and the usage of the processing unit or said one or more system resources required by the image viewing and processing application;
displaying the usage of the processing unit or said one or more system resources consumed by said other computing-processes associated with other applications and displaying options to select one or more other applications for termination via a user interface if the adequacy of the processing unit or said one or more system resources for executing the image viewing and processing application is not satisfied; and
terminating said one or more other applications selected to reduce the usage of the processing unit or said one or more system resources consumed by said other computing-processes on the computer so as to ensure the adequacy of the processing unit or said one or more system resources for executing the image viewing and processing application.
